(19) United States
(12) Patent Application Publication
(10) Pub. No.: US 2002/0170402 A1
(43) Pub. Date: Nov. 21, 2002

(54) Feeding device, especially for cord tape

(76) Inventor: Bernd Hoffmann, Burgkunstadt (DE)

Correspondence Address: JORDAN AND HAMBURG LLP, 122 EAST 42ND STREET, SUITE 4000, NEW YORK, NY, 10168, US

(21) Appl. No.: 10/095,948

(22) Filed: Mar. 12, 2002

(30) Foreign Application Priority Data
Mar. 20, 2001 (DE) 101 13 379.0-22

(51) Int. Cl. B26D 7/02

(52) U.S. Cl. 83/206; 83/277; 83/451

(57) ABSTRACT

A feeding device for transporting a thin and sticky tape, particularly a cord tape, through a cutting device onto a conveyor belt for transporting the sections of cord tape away, with a pulling device with pliers, which take hold of the leading edge of the cord tape lying under the raised upper knife of the cutting device, in order to pull the cord tape by a distance, corresponding to the width of the cutting, from the unwinding roll through the cutting device over the conveyor belt, which transports the cutting away and preferably lies lower.

The invention relates to a feeding device for transporting a thin and sticky tape, particularly a cord tape, through a cutting device onto a conveyor belt for transporting away the sections of cord tape.

In the case of the previously known feeding devices, the cord tape, generally pulled off from a supply roll, is pushed through the cutting device, as a result of which, however, a series of difficulties arises in practice. On the one hand, only a limited feeding length is possible. Because the transport of the material is affected by friction, the danger of a back-up of material as well as of dimensional inaccuracies due to the distortion of the cord tapes, during the pushing operation, arises. For very thin and labile steel and textile cord tapes as well as for other rubber materials, which are subjected to stresses, the known feeding devices can no longer be used for materials<0.5 mm thick and for feeding lengths>800 mn. The previously known feeding devices can be used without problems only for thicker steel or textile cord tapes, which are less affected by stresses, as well as for appropriately thick rubber bands.

It is therefore an object of the invention to develop a feeding device, especially for thin and sticky cord tapes, so that also thin and very sticky cord tapes can be transported without problems and without the danger of distortion.

Pursuant to the invention, this objective is accomplished by a feeding device of the type named above, which is characterized by a pulling device with pliers, taking hold of the leading edge of the cord tape lying under the raised upper knife of the cutting device, in order to pull the cord tape by a distance, corresponding to the width of the cutting, from the unwinding roll through the cutting device over the conveyor belt, which transports the cutting away and preferably lies lower.

By replacing the previous pushing system with a pulling device, the disadvantages of the previously known feeding devices, such as a back-up of material, a distortion of the cord tape and a limited feeding length, can be avoided completely and, with that, it is also possible to process thin and sticky tapes, without running the risk of distorting the severed cord tape section.

In a further development of the invention, provisions can be made that the holding down device with a clamping device for raising the advancing cord tape section is disposed ahead of the cutting device in the running direction. The holding down device secures the tape during the cutting off operation and prevents movements during the cutting process, which could lead to a defective step or a distortion of the tape. On the other hand, after the cut, the holding down device, which is provided with a clamping device, can raise the advancing cord tape, so that the pliers easily can take hold of the free edge of the cord tape. In the case of a cord tape resting on a conveyor table or belt, this can cause obvious difficulties, since moving the pliers under the thin cord tape, lying on the support, causes major problems.

Pursuant to a further distinguishing feature of the present invention, provisions can be made that the holding down device represents a plate, preferably the lower wall of a rectangular pipe, which is provided with recesses for magnets, preferably permanent magnets, the height of which relative to the plate can be adjusted and to which a ferromagnetic clamping strip, which takes hold of the cord tape from below and is guided preferably vertically at its ends, is assigned.

Because the permanent magnets protrudes into the recesses, the clamping strip is connected with the holding down device and the cord tape is clamped between the two, so that, when the holding down device is raised, the cord tape is also raised along with it. However, if such a raising does not to take place, namely, when the pliers, in which the cord tape is clamped, are moved away from the cutting device in order to pull the cord tape through the cutting device, the permanent magnets are previously raised with respect to the downwardly moved holding down device, so that the magnetic connection to the clamping strip is canceled. When the holding down device subsequently is raised, the clamping strip remains in place and the cord tape can then be pulled through the cutting device without hindrance.

Moreover, it is finally also still within the scope of the invention that the pulling device can be moved independently of one another perpendicularly as well as parallel to the cutting edge of the cutting device, so that it is possible not only to convey the cord tape sections, the cut edge of which extends perpendicularly to the longitudinal direction of the cord tape, but also the cord tape sections with oblique cut edges, which are generally required in practice. The servomotors for shifting the pulling device in a perpendicular and parallel direction are controlled as a function of the cutting angle that is desired. In this connection, it is, of course, self-evident that, in the case of such oblique cuts, the supplying device, with which the cord tape is transported from the supply roll to the cutting device, is also swiveled at an appropriate angle to the cutting edge of the cutting device.

Further advantages, distinguishing features and details of the invention arise out of the following description of an example as well as from the drawing, in which

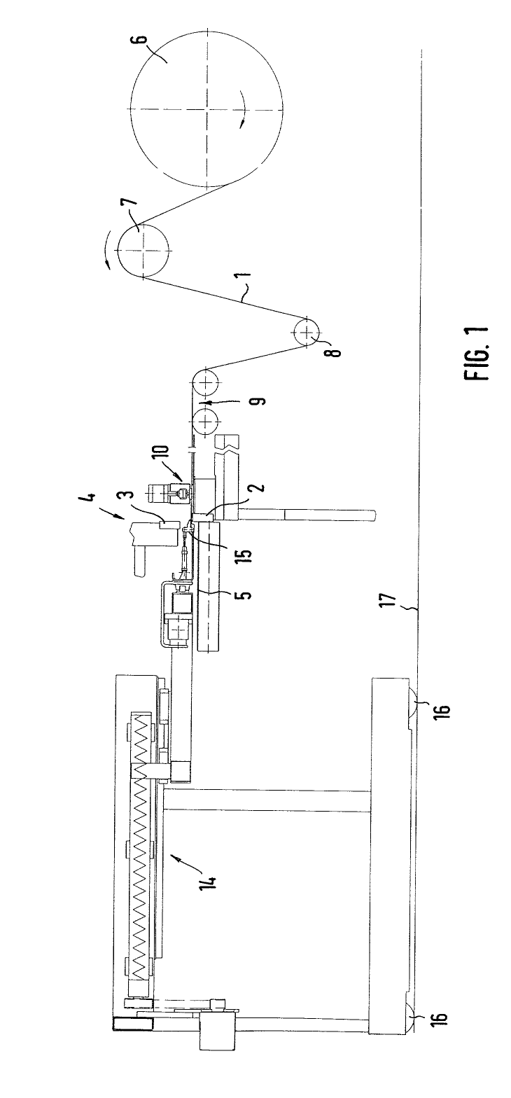

FIG. 1 shows a diagrammatic side view of an inventive feeding device, only the two knives of the cutting device being shown,

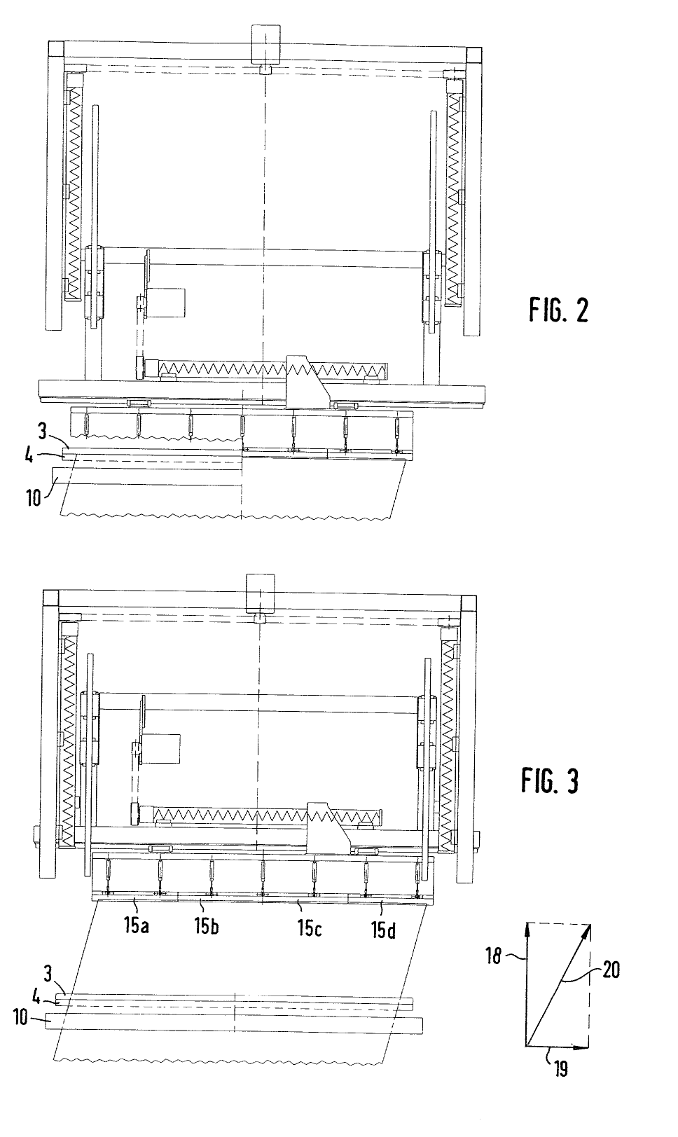

FIG. 2 shows a plan view of the feeding device in the region of the cutting edge in the basic position of the pliers at the knife of the cutting device,

FIG. 3 shows a plan view, corresponding to that of FIG. 2, in a position, in which the pliers have moved back by pulling the cord tape through the cutting device and

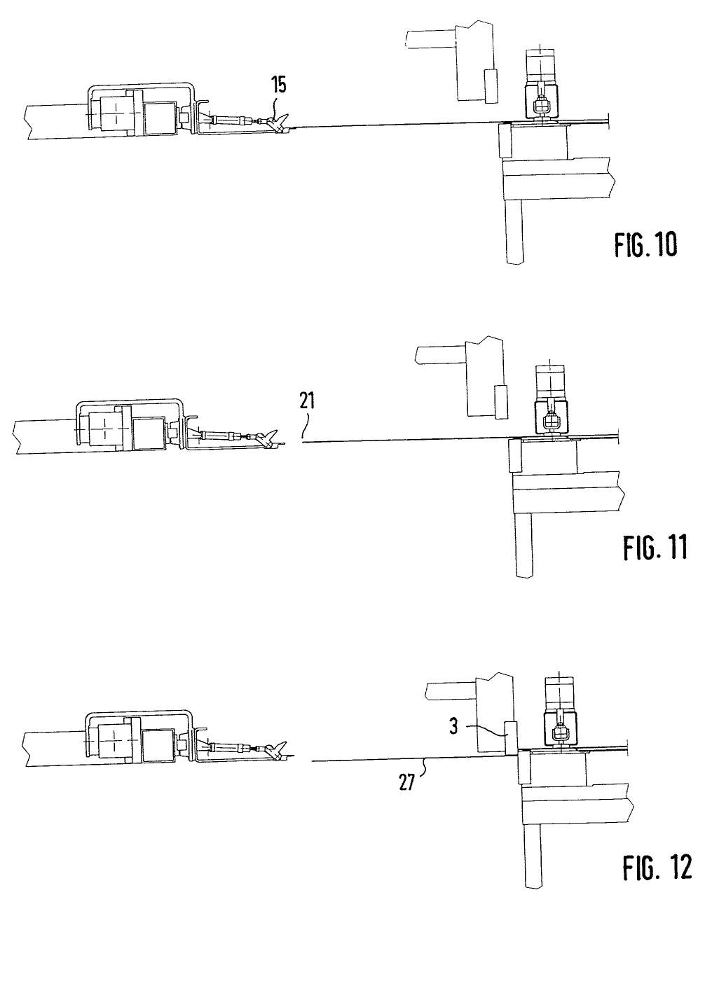

FIGS. 4 to 13 show diagrammatic partial side views of the pliers and the cutting knives with the holding down device in different working positions while the cord tape is being pulled through, and of the transport of the cord tape sections on the conveyor belt, which is shown only in FIG. 1, for transporting the sections of cord tape away. In the remaining Figures, this transporting conveyor belt has been omitted, as has the supplying conveyor belt, which is also indicated diagrammatically in FIG. 1 between the supplying roll and the cutting device, since these conveyor belts are known and the identification of the special features of the inventive supplying device would only be made more difficult.

The cord tape 1, from which cuttings, which are transported from the cutting device 4 by a conveyor belt 5, are to be severed by means of the cutting device 4 shown diagrammatically, namely by its cutting knives (lower knife 2 and movable upper knife 3), is pulled off from a supply roll 6 and supplied over various guide rollers 7 and 8, by which a supply loop is also formed, to an inlet conveyor belt 8. The supplying device 9 can be swiveled appropriately from the vertical alignment of its longitudinal axis to the cutting edges of the lower knife 2 and the upper knife 3, depending on how the cutting angle is to be in relation to the longitudinal direction of its cord tape.

At 10, a holding down device is shown, which will be described in greater detail below and presses the cord tape 1 against the inlet conveyor belt 9 or against a cutting table. An inventive pulling device is labeled 14, with the help of which the front end of the cord tape, which can be taken hold of by pliers 15, is pulled through the cutting device 4, in order to avoid the already addressed disadvantages of the previous feeding devices. The running wheels 16 of the pulling device 14 function only to make the pulling system basically mobile. During the actual operation, these running wheels 16 do not play a role, the pulling device 14 is blocked with respect to the floor 17 and the pliers 15 are shifted exclusively over two driving devices, the details of which are not described. The one driving device pulls the pliers 15 perpendicularly to the edge of the knife and the other one pulls the pliers 15 parallel thereto, so that, by appropriately setting the speeds of motion, any pull off angle at all can be achieved. This is shown in a diagram in FIG. 3. The arrow 18 shows the path of motion of the pliers along an axis perpendicularly to the knife, the arrow 19 shows the path of motion of the pliers along an axis parallel to the knife and 20 shows the resulting path of motion of the pliers and its inclination to the cutting edge.

In FIG. 4, the basic position is shown, in which the holding down device 10, which comprises essentially a rectangular pipe, is lifted while the cord tape 1 is clamped and the pliers 15 are open and lie directly in front of the advancing edge 21 of the cord tape. The cutting device is also open. This means that the upper knife 3 has been moved upwards.

In the lower wall 22 of the rectangular pipe of the holding down device 10, recesses, the details of which are not shown, are disposed at a distance from one another over the whole length. In the upper part 23, permanent magnets 24 can be moved into the recesses by seromotors. In the position, in which they are disposed in the recesses, that is, for example, in FIG. 4, these permanent magnets pull a ferromagnetic clamping strip 25, which is disposed underneath the cord tape and, in this manner, clamp the cord tape 1 at the holding down device 10, so that, if the holding down device 10 is raised this position, the cord tape 1 is also raised from the cutting table 26, that is, for example, into the basic position shown in FIG. 4.

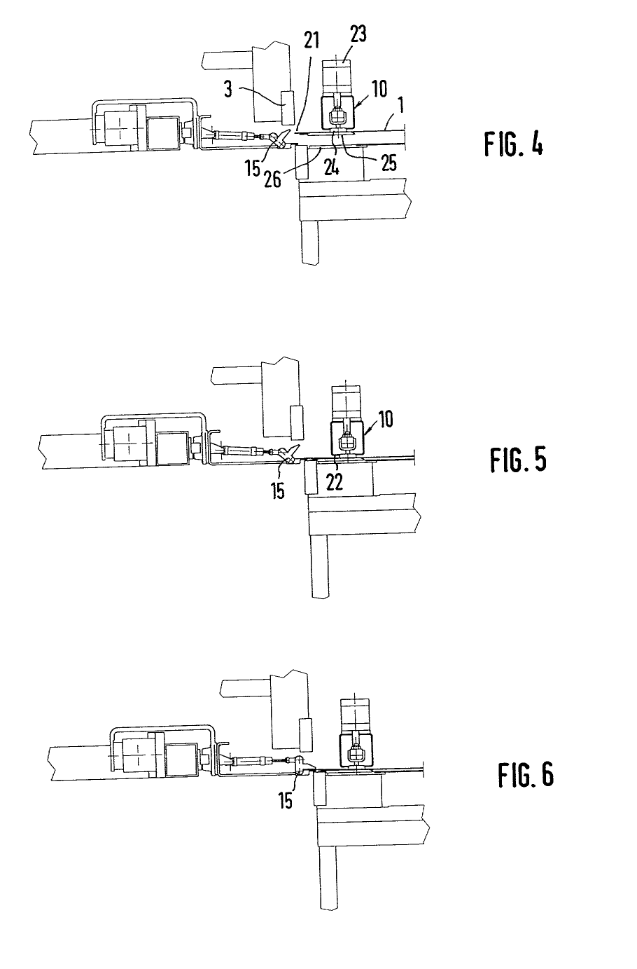

From the basic position of FIG. 4, the holding down device 10 is moved downward (FIG. 5), as a result of which the leading edge 21 of the cord tape 1 is placed on the open pliers 15. Subsequently, the pliers 15 are closed, as shown in FIG. 6.

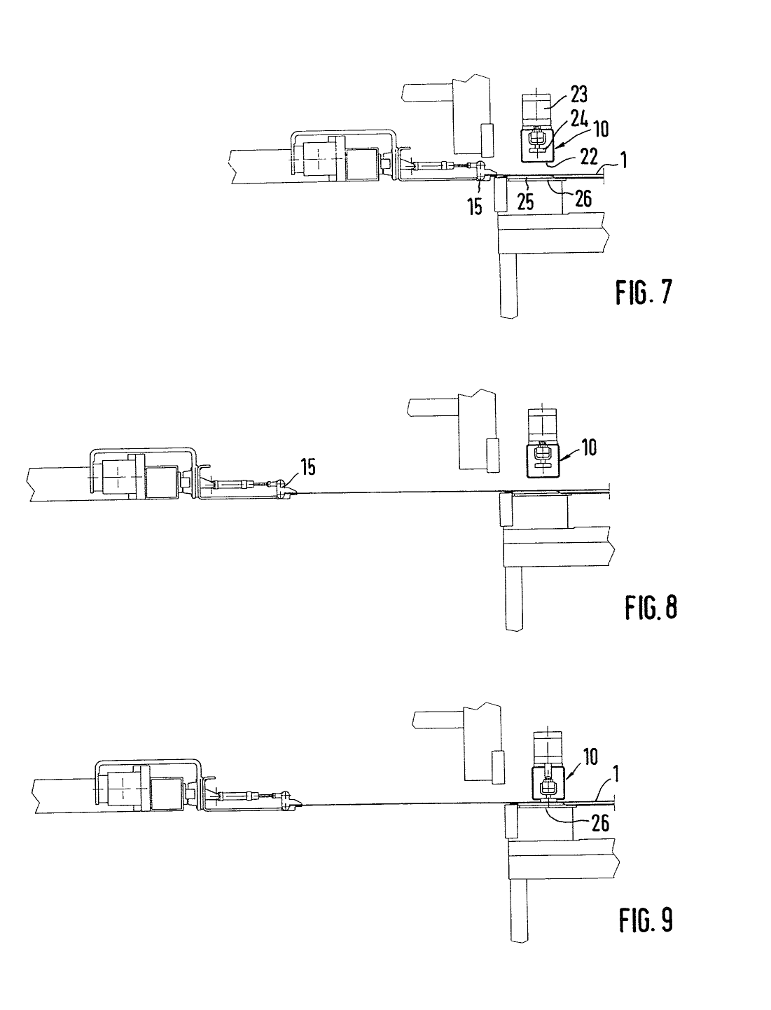

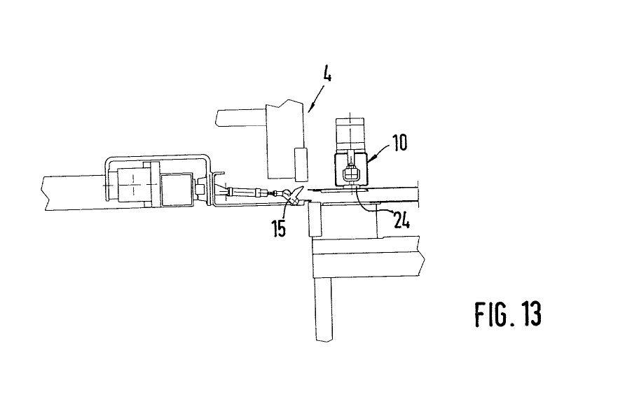

In the next step, initially the permanent magnets within the holding down device 24 are moved upward, so that the frictional connection with the clamping strip 25 is cancelled. If the holding down device 10 is now moved upward into the position of FIG. 7, the clamping strip 25 remains on the clamping table 26, as does the cord tape 1. The material, that is, the cord tape is no longer clamped. The actual pulling of the cord tape 1 through the cutting device takes place now in that the pliers are retracted into the position shifted to the left in FIG. 8. With this shifting perpendicularly to the knives of the cutting device 4, superimposed shifting of the pliers 15 parallel to the cutting edges of the knives can take place, as has already been mentioned frequently, in order to produce correspondingly obliquely cut cord tape sections. After the cord tape is pulled through the open cutting device into the position of FIG. 8, it being possible, of course, to adjust the length of the section pulled through to any value by moving the pliers, the holding down device 10 is moved downward again into the position of FIG. 9, where it clamps the cord tape 1 on the cutting table 26. Thereupon, the pliers 15 open up and a further piece is moved to the left in order to release the leading end 21 of the cord tape 1 (position of FIG. 11), so that, during the subsequent cut by moving the upper knife 3 downward, a cord tape section 27 is produced, which is free of any distortions. This cut-off cord tape section 27 falls onto the transporting conveyor belt 5, as indicated in FIG. 1, and with the help of the latter is transported to a station, at which it is processed further. Subsequently, the cutting device is opened and the holding down device, with the permanent magnets 24 moved downward, is moved upward once again, while the pliers 15 are once again brought into position from the left in front of the cutting device 4 (FIG. 13). The starting position of FIG. 4 is then reached once again in FIG. 13 and the cycle of pulling through, cutting off and transporting the cord tape sections away can be commenced once again.

It can be seen from FIGS. 2 and 3 that the pliers 15 consist of several sections 15a, 15b, 15c, 15d, which are disposed next to one another and can be controlled individually. This makes better clamping possible over the whole width of the cord tape independently of the actual width of the latter. In the case of one-piece pliers of appropriate length, difficulties can arise during the clamping, in that frictional clamping in the pliers does not take place over the whole edge of the cord tape. In view of the tensile stresses that arise, this could lead to a distortion of the tape over the width. However, such distortions are to be avoided at all costs, since they must lead to defects during the subsequent, further processing by splicing the initially-formed cord tape sections together.

1. A feeding device for transporting a thin and sticky tape, particularly a cord tape, through a cutting device onto a conveyor belt for transporting the sections of cord tape, which is characterized by a pulling device (14) with pliers (15), which take hold of the leading edge (21) of the cord tape lying under the raised upper knife (3) of the cutting device (4), in order to pull the cord tape (1) by a distance, corresponding to the width of the cutting, from the unwinding roll (6) through the cutting device (4) over the conveyor belt (5), which transports the cutting away and preferably lies lower.

2. The feeding device of claim 1, wherein a holding down device (10), with a clamping device for raising the advancing cord tape, is disposed, in the conveying direction, ahead of the cutting device (4).

3. The feeding device of claim 2, wherein the holding down device (10) represents a plate, preferably the lower wall (22) of a rectangular pipe, which is provided with recesses for magnets, preferably permanent magnets (24), the height of which can be adjusted relative to the plate and to which a ferromagnetic clamping strip (25), which takes hold of the cord tape (1) from below and is guided preferably vertically at its ends, is assigned.

4. The feeding device of claims 1 to 3, wherein the pliers (15) can be moved over the pulling device (14) independently of one another perpendicularly as well as parallel to the cutting edge of the cutting device (4).

5. The feeding device of one of the claims 1 to 4, wherein the pliers (15) consist of several sections (15a, 15b, 15c, 15d), which can be clamped indecently of one another.
